(19) United States
(12) Patent Application Publication
(10) Pub. No.: US 2010/0202340 A1
(43) Pub. Date: Aug. 12, 2010

(54) SYSTEM AND METHOD OF CONSTRUCTING A RESOURCE MATRIX FOR TRANSMITTING MULTICAST BROADCAST SERVICE (MBS) DATA

(75) Inventors: Kaushik Josiam, Dallas, TX (US); Zhouyue Pi, Richardson, TX (US)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/693,290

(22) Filed: Jan. 25, 2010

Related U.S. Application Data
(60) Provisional application No. 61/207,189, filed on Feb. 9, 2009.

(51) Int. Cl. H04H 20/71

(52) U.S. Cl. 370/312

(57) ABSTRACT

A base station comprises a controller configured to construct a resource matrix comprising resource units. The controller also is configured to allocate a plurality of resource units within the resource matrix containing resource units that carry Enhanced-Multicast Broadcast Service (E-MBS) data, and to generate at least two indicator values. The at least two indicator values are configured to identify at least some of the plurality of resource units containing E-MBS data within the resource matrix. The base station further comprises a transmitter configured to transmit the E-MBS data placed in the resource matrix and the at least two indicators to a subscriber station.

### CROSS-REFERENCE TO RELATED APPLICATION(S) AND CLAIM OF PRIORITY

The present application is related to U.S. Provisional Patent Application No. 61/207,189, filed Feb. 9, 2009, entitled “SIGNALING METHOD TO INDICATE A PLURALITY OF TRANSMISSION CYCLES AND RESOURCE ALLOCATION IN MULTICAST BROADCAST SERVICES”. Provisional Patent Application No. 61/207,189 is assigned to the assignee of the present application and is hereby incorporated by reference into the present application as if fully set forth herein. The present application hereby claims priority under 35 U.S.C. §119(e) to U.S. Provisional Patent Application No. 61/207,189.

### TECHNICAL FIELD OF THE INVENTION

The present application relates generally to wireless communications and, more specifically, to a system and method for transmitting Multicast Broadcast System (MBS) data.

### BACKGROUND OF THE INVENTION

Multimedia entertainment on mobile stations (MSs) or subscriber stations (SSs) is a key driver in influencing the demand for higher data rates and improved user services. To address multimedia entertainment in next generation wireless systems, different standard bodies have optimized the transmission of multimedia broadcast services. In 3^{rd} Generation Partnership Project (3GPP), the multimedia content is carried on Multimedia Broadcast Multicast Service (MBMS). In 3^{rd} Generation Partnership Project 2 (3GPP2), multimedia content is transmitted using Multicast Broadcast Multicast Service (BCMCS).

The Institute of Electrical and Electronics Engineers (IEEE) 802.16e standard describes Multicast and Broadcast Service (MBS), which is a downlink only offering that provides an efficient method of simultaneously transmitting multimedia content to a group of users. MBS saves resources by allocating the same radio resource to all users registered to the same service instead of allocating as many radio resource as there are users. Moreover, in a multi-base station (multi-BS) MBS system, MSs registered to an E-MBS service can receive MBS information from any base station (BS) in a particular MBS zone without being registered with a specific BS in that zone.

The IEEE 802.16m standard, currently under development, is an enhanced update to the existing IEEE 802.16e standard. The enhanced version of MBS in IEEE 802.16m is termed Enhanced-Multicast Broadcast Service (or E-MBS).

### SUMMARY OF THE INVENTION

A base station is provided. The base station comprises a controller configured to construct a resource matrix comprising resource units. The controller also is configured to allocate a plurality of resource units within the resource matrix containing resource units that carry Enhanced-Multicast Broadcast Service (E-MBS) data, and to generate at least two indicator values. The at least two indicator values are configured to identify at least some of the plurality of resource units containing E-MBS data within the resource matrix. The base station further comprises a transmitter configured to transmit the E-MBS data placed in the resource matrix and the at least two indicators to a subscriber station.

A method of transmitting Multicast Broadcast Service (MBS) data is provided. The method comprises constructing a resource matrix comprising resource units, and allocating a plurality of resource units within the resource matrix containing resource units that carry Enhanced-Multicast Broadcast Service (E-MBS) data. The method also comprises generating at least two indicator values. The at least two indicator values are configured to identify at least some of the plurality of resource units containing E-MBS data. The method further comprises transmitting the E-MBS data placed in the resource matrix and the at least two indicators to a subscriber station.

A subscriber station is provided. The subscriber station comprises a receiver configured to receive a resource matrix and at least two indicators. The subscriber station further comprises a controller configured to use the at least two indicators to determine a plurality of resource units within the resource matrix that carry Enhanced-Multicast Broadcast Service (MBS) data, and to recover E-MBS data from the plurality of resource units within the resource matrix that carry E-MBS data.

A method of receiving Enhanced-Multicast Broadcast Service (E-MBS) data is provided. The method comprises receiving a resource matrix and at least two indicators, and using the at least two indicators to determine a plurality of resource units within the resource matrix that carry E-MBS data. The method further comprises recovering E-MBS data from the plurality of resource units within the resource matrix that carry E-MBS data.

A wireless communication network comprising a plurality of base stations capable of wireless communication with a plurality of subscriber stations within a coverage area of the network is provided. At least one of the plurality of base stations comprises a controller configured to construct a resource matrix comprising resource units. The controller also is configured to allocate a plurality of resource units within the resource matrix containing resource units that carry Enhanced-Multicast Broadcast Service (E-MBS) data, and to generate at least two indicator values. The at least two indicator values are configured to identify at least some of the plurality of resource units containing E-MBS data within the resource matrix. The base station further comprises a transmitter configured to transmit the E-MBS data placed in the resource matrix and the at least two indicators to a subscriber station.

A base station is provided. The base station comprises a controller configured to identify a resource matrix in a time-frequency domain, to allocate a plurality of resource units within the resource matrix to carry a data stream, wherein the resource matrix comprises a plurality of resource units, and to generate a message comprising at least two indicators identifying a resource unit within the resource matrix. The resource unit indicates one of a first and a last resource unit of the data stream. The base station further comprises a transmitter configured to transmit the data stream and the message.

A wireless communication network comprising a plurality of base stations capable of wireless communication with a plurality of subscriber stations within a coverage area of the network is provided. At least one of the plurality of base stations comprises a controller configured to identify a resource matrix in a time-frequency domain, to allocate a plurality of resource units within the resource matrix to carry a data stream, wherein the resource matrix comprises a plurality of resource units, and to generate a message comprising at least two indicators identifying a resource unit within the resource matrix. The resource unit indicates one of a first and a last resource unit of the data stream. The base station further comprises a transmitter configured to transmit the data stream and the message.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary wireless network that transmits messages in the downlink according to the principles of the present disclosure;

FIGS. 2A and 2B illustrate the structure of the time-frequency resources of an orthogonal frequency division multiplexing (OFDM) modulation scheme according to an embodiment of the present disclosure;

FIG. 3 illustrates an MBS scheduling interval (MSI) transmitting different MBS streams according to embodiments of the present disclosure;

FIG. 4 illustrates a method of constructing a resource matrix according to embodiments of the present disclosure;

FIG. 5 illustrates a method of receiving Multicast Broadcast Service (MBS) data according to embodiments of the present disclosure;

FIG. 6A illustrates a resource matrix formed by aggregating the data-carrying resource units (RUs) in an MBS scheduling interval (MST) according to embodiments of the present disclosure;

FIG. 6B illustrates a resource matrix formed by aggregating the MBS data-carrying resource units (RUs) in E-MBS scheduling interval (MSI) without reordering the data-carrying RUs according to embodiments of the present disclosure;

FIG. 7 illustrates the use of resource trees to indicate resource units in a resource matrix according to embodiments of the present disclosure;

FIG. 8 illustrates the use of resource trees indicate resource units in a resource matrix according to other embodiments of the present disclosure;

FIG. 9 illustrates a resource matrix having a plurality of contiguous blocks allocated in one dimension according to embodiments of the present disclosure;

FIG. 10 illustrates block allocation according to embodiments of the present disclosure;

FIG. 11 illustrates best-M allocation according to embodiments of the present disclosure;

FIG. 12 illustrates a column-wise best-M and row-wise tree allocation according to embodiments of the present disclosure; and

FIG. 13 illustrates a further channelization for resource allocation on a resource matrix according to embodiments of the present disclosure.

### DETAILED DESCRIPTION OF THE INVENTION

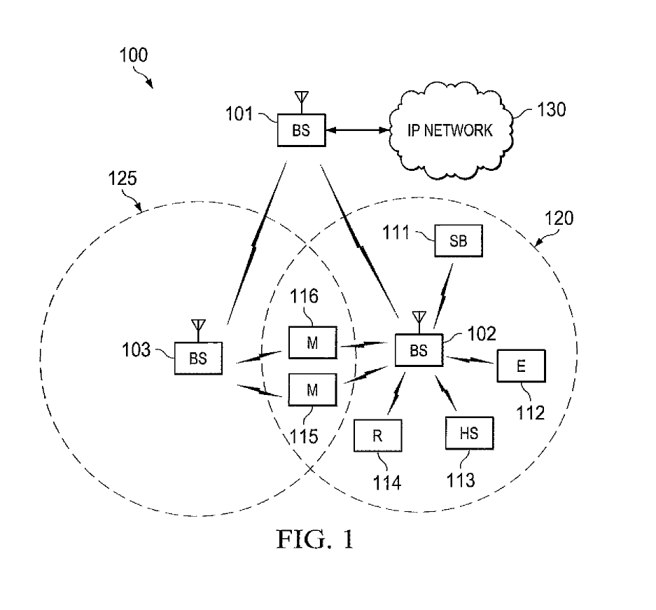

FIGS. 1 through 13, discussed below, and the various embodiments used to describe the principles of the present disclosure in this patent document are by way of illustration only and should not be construed in any way to limit the scope of the present disclosure. Those skilled in the art will understand that the principles of the present disclosure may be implemented in any suitably arranged wireless communication system.

FIG. 1 illustrates an exemplary wireless network 100, which transmits messages according to the principles of the present disclosure. In the illustrated embodiment, wireless network 100 includes a base station (BS) 101, a base station (BS) 102, a base station (BS) 103, and other similar base stations (not shown). Base station 101 is in communication with Internet 130 or a similar IP-based network (not shown).

Base station 102 provides wireless broadband access (via base station 101) to Internet 130 to a first plurality of subscriber stations within coverage area 120 of base station 102. The first plurality of subscriber stations includes subscriber station 111, which may be located in a small business (SB), subscriber station 112, which may be located in an enterprise (E), subscriber station 113, which may be located in a WiFi hotspot (HS), subscriber station 114, which may be located in a first residence (R), subscriber station 115, which may be located in a second residence (R), and subscriber station 116, which may be a mobile device (M), such as a cell phone, a wireless laptop, a wireless PDA, or the like.

Base station 103 provides wireless broadband access (via base station 101) to Internet 130 to a second plurality of subscriber stations within coverage area 125 of base station 103. The second plurality of subscriber stations includes subscriber station 115 and subscriber station 116. In an exemplary embodiment, base stations 101-103 may communicate with subscriber stations 111-116 using OFDM or OFDMA techniques.

Base station 101 may be in communication with either a greater number or a lesser number of base stations. Furthermore, while only six subscriber stations are depicted in FIG. 1, it is understood that wireless network 100 may provide wireless broadband access to additional subscriber stations. It is noted that subscriber station 115 and subscriber station 116 are located on the edges of both coverage area 120 and coverage area 125. Subscriber station 115 and subscriber station 116 each communicate with both base station 102 and base station 103 and may be said to be operating in handoff mode, as known to those of skill in the art.

Subscriber stations 111-116 may access voice, data, video, video conferencing, and/or other broadband services via Internet 130. In an exemplary embodiment, one or more of subscriber stations 111-116 may be associated with an access point (AP) of a WiFi WLAN. Subscriber station 116 may be any of a number of mobile devices, including a wireless-enabled laptop computer, personal data assistant, notebook, handheld device, or other wireless-enabled device. Subscriber stations 114 and 115 may be, for example, a wireless-enabled personal computer (PC), a laptop computer, a gateway, or another device.

Enhanced-Multicast Broadcast Service (E-MBS) is a downlink transmission from a base station (BS) to mobile stations (MSs) optimized in IEEE 802.16m systems for multimedia transmissions like mobile TV. The control signaling that is required to decode E-MBS data at the MS is transmitted as an E-MBS MAP message. The decoding information for all E-MBS data bursts in an E-MBS zone will be transmitted in the E-MBS MAP. As a result, the E-MBS MAP contains Information Elements (IEs) for each of the services offered. Each E-MBS service is identified by a unique Multicast Station ID (MSTID), flow ID (FID), or Multicast Connection ID (MCID). In some embodiments, MSTIDs or FIDs having the same decoding information may be grouped in the same IE to increase efficiency. To accommodate different transmission scenarios, different types of IEs have been described. In IEEE 802.16e systems, an IE is categorized as an MBS_DATA_IE, an MBS_DATA_Time_Diversity_IE, or an Extended_MBS_DATA_IE. Depending on the transmission scenario for the MSTIDs or FIDs in the zone, the MBS MAP may contain some or all of the IEs.

If the MBS data bursts have different transmission cycles, the IEs for the MCIDs of such services will be different. In effect, for the MCIDs to be grouped into the same IEs, the data bursts associated with the MCIDs will have to have the same physical layer parameters and the same transmission frequency. If they use the same MCS but are transmitted with different duty cycles, the MCIDs will be carried in different IEs. Currently, in each IE, 8 bits are used to indicate the time offset and 6 bits are used to indicate the frequency offset for IEEE for each transmission instance of the MCID. However, such a method of constructing a MAP results in high overhead and is inefficient.

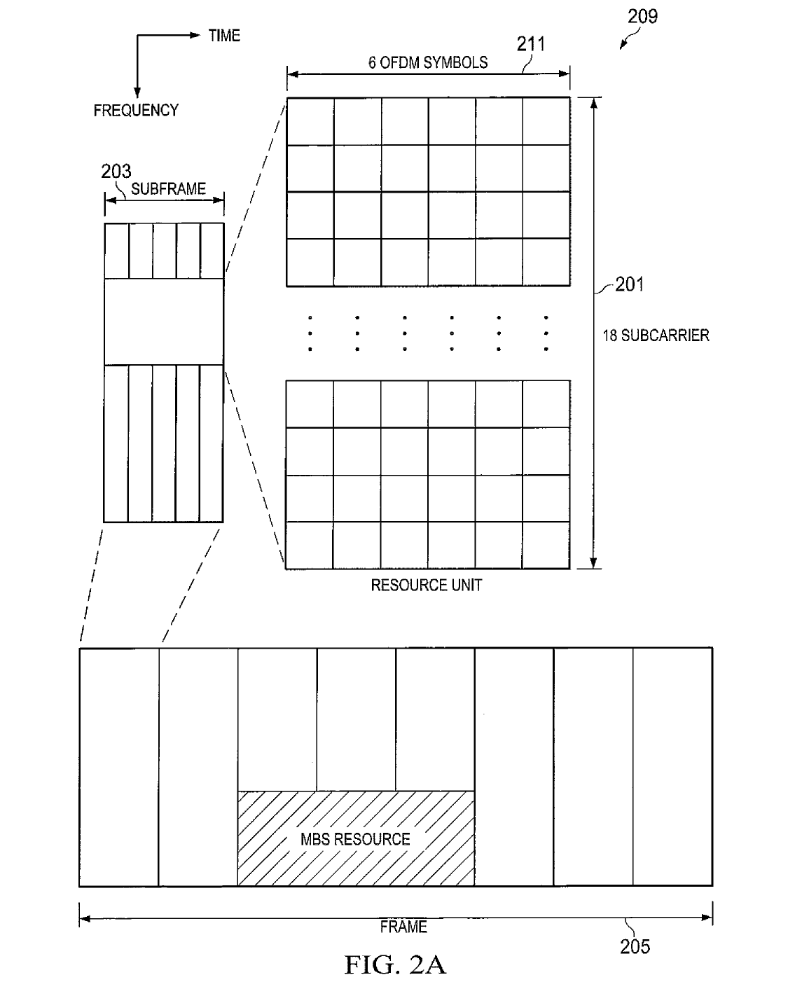

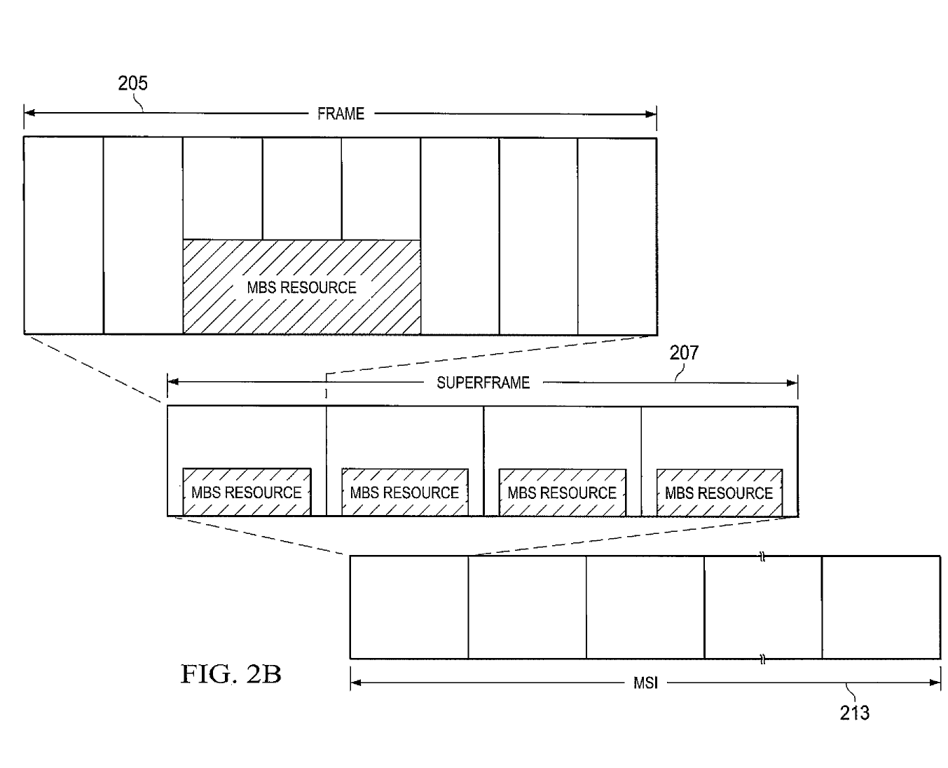

FIGS. 2A and 2B illustrate the structure of the time-frequency resources of an orthogonal frequency division multiplexing (OFDM) modulation scheme according to an embodiment of the present disclosure.

The downlink of IEEE 802.16m uses an orthogonal frequency division multiplexing (OFDM) modulation scheme to transmit information to the MS. OFDM is a multi-carrier technique where the available bandwidth is split into many small bands known as subcarrier using simple IFFT/FFT operations. The bandwidth for each subcarrier is the same. The subcarriers are used to carry either control signaling or data for the MSs. As shown in FIGS. 2A and 2B, an OFDM symbol is a collection of subcarriers that span the system bandwidth. Further, to make resource utilization efficient, the OFDM symbols are grouped to form a sub-frame 203. In IEEE 802.16m, 6 OFDM symbols are used to form a regular sub-frame that is 0.625 ms long. 8 such regular sub-frames form a frame 205 that is 5 ms long. 4 frames form a super-frame 207 that spans 20 ms.

To achieve granularity in resource utilization while keeping the signaling simple, the subcarriers in a sub frame are grouped to form a resource. This portion of the time-frequency resource is sometimes called a resource block (RB) or a virtual resource block (VRB), a resource unit (RU) or a logical resource unit (LRU), or a resource channel (RCH). For the sake of convenience, a portion of the time-frequency resource will be referred as a resource unit (RU) throughout this disclosure. In IEEE 802.16m system, an RU 209 is rectangular tile made of 18 subcarriers 201 in frequency dimension and 6 OFDM symbols 211 in the time dimension.

There are different types of time-frequency RUs, such as distributed logical resource unit (distributed LRU) and localized logical resource unit (localized LRU), in IEEE 802.16m systems. In general, there are multiple RUs in a system, and these RUs can be allocated for transmitting data packets. Accordingly, the allocation of these RUs needs to be communicated to the intended one or more mobile stations using signaling messages or control channel messages. In the downlink of an OFDMA system, for example, in addition to transmitting a data packet, the base station needs to communicate to the intended one or more mobile stations the information regarding the resources allocated to the transmission of the data packet in order for the MSs to determine which RUs to decode to retrieve the data packet.

An E-MBS Scheduling Interval (MSI) 213 refers to a number of successive frames for which the access network may schedule traffic for the streams associated with the E-MBS prior to the start of the interval. The length of this interval depends on the particular use case of the E-MBS and is dictated by the minimum switching time requirement set in the IEEE 802.16m System Requirements Document (SRD). In other words, MSI refers to the transmission frequency of the E-MBS MAP. Additionally, the E-MBS MAP message may be structured such that the E-MBS MAP efficiently defines multiple transmission instances for a given stream within an MSI. In an MSI, there is just one MAP and this MAP is used to signal all MBS data flows in the MSI. As can be inferred from the definition, the length of an MSI is an integer multiple of the frame length (for example, an integer multiple of 5 ms).

Different multicast services may require different transmission cycles within an MSI to offer consistent services at the MS. For example, the multicast services could be multimedia text messages transmitting advertisements, broadcast TV, dynamic multicast, high definition (HD) broadcast, etc. Each of the multicast services will have different transmission cycles and require different amounts of RUs.

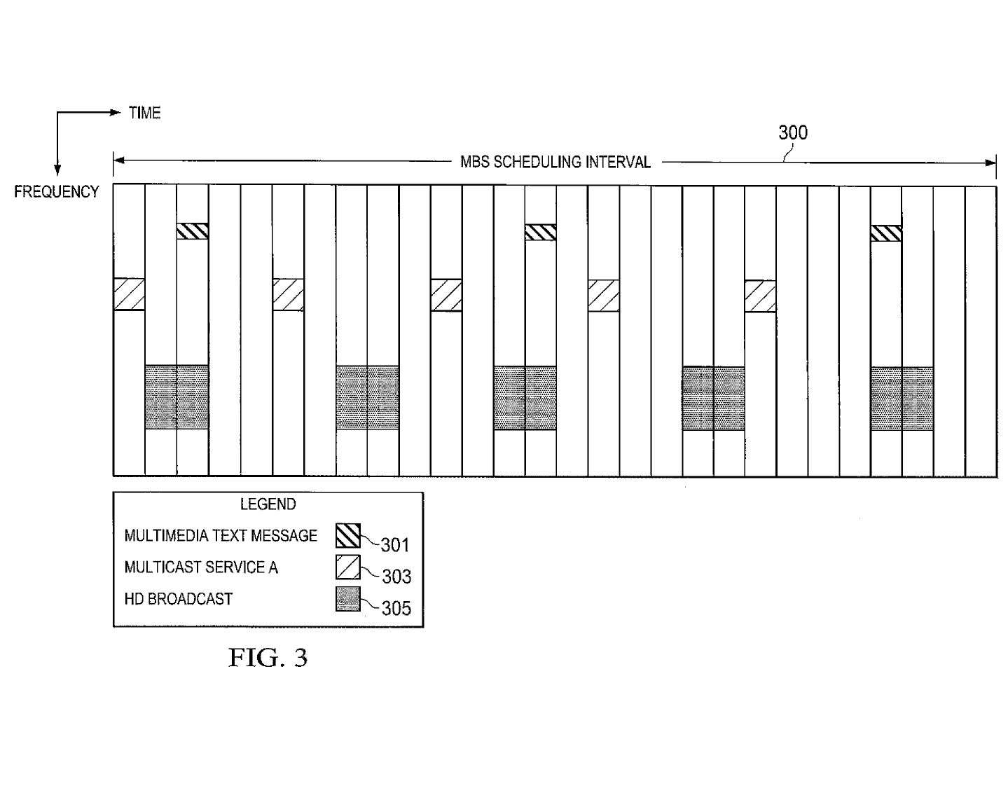

FIG. 3 illustrates an MBS scheduling interval (MSI) 300 transmitting different MBS streams according to embodiments of the present disclosure. For example, multimedia text messages 301 are transmitted 3 times in MSI 300. A multicast service 303 is transmitted 5 times in MSI 300, while an HD broadcast 305 is transmitted 10 times.

In an MSI, there are numerous RUs available to the BS to schedule the different MBS streams. These RUs can be physical which refer to the actual subcarriers in the OFDM symbols or logical where only the indices of the subcarriers are combined to form an RU. In a logical RU, the mapping between the physical subcarrier and its logical index has to be defined. For example, a logical RU can be made of 18 subcarriers that are taken from subcarriers spread evenly throughout the bandwidth. The logical RU allows extraction of the frequency diversity that the MBS transmission offers. The system and method provided in the present disclosure can be applied to both physical and logical RUs.

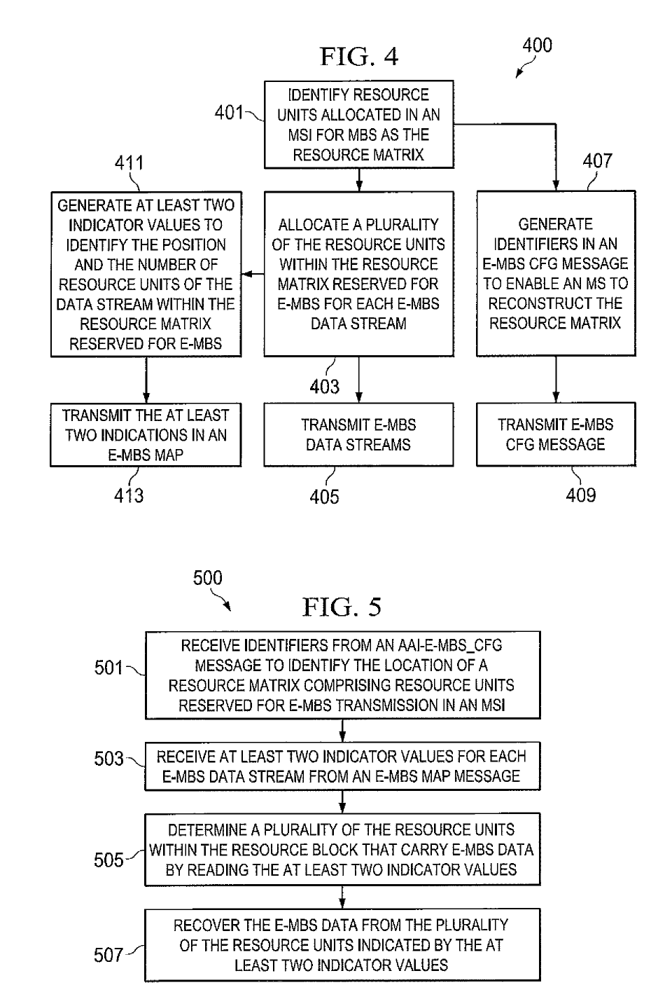

FIG. 4 illustrates a method 400 of constructing a resource matrix according to embodiments of the present disclosure. The embodiment of method 400 shown in FIG. 4 is for illustration only. Other embodiments could be used without departing from the scope of this disclosure.

As shown in FIG. 4, on a first channel, a base station identifies a resource matrix using resource units allocated in an MSI for E-MBS (block 401). The base station allocates a plurality of the resource units within the resource matrix for transmitting Enhanced-Multicast Broadcast Service (E-MBS) data for each E-MBS data stream (block 403), and transmits the E-MBS data streams (block 405). The set of resources reserved for transmitting E-MBS data in an MSI is termed the resource matrix. On a second channel, identifiers that are necessary to identify the resources reserved for E-MBS that enable construction of the resource matrix at the MSs are generated (block 407) and transmitted in a configuration message called the Advanced Air Interface-E-MBS Configuration channel (AAI-E-MBS_CFG) message (block 409). On a third channel, the base station generates at least two indicator values (block 411). The indicator values are configured to identify at least some of the plurality of resource units transmitting or not transmitting E-MBS data. The at least two indicators are transmitted to a subscriber station in an E-MBS MAP (block 413).

FIG. 5 illustrates a method 500 of receiving Multicast Broadcast Service (MBS) data according to embodiments of the present disclosure. The embodiment of method 500 shown in FIG. 5 is for illustration only. Other embodiments could be used without departing from the scope of this disclosure.

As shown in FIG. 5, a subscriber station receives the identifiers from the AAI-E-MBS_CFG message to identify the location of the resource matrix comprising resource units reserved for E-MBS transmission in the MSI (block 501). The subscriber station then receives at least two indicator values for each E-MBS data stream from the E-MBS MAP message (block 503). The subscriber station determines a plurality of the resource units within the resource block that carry E-MBS data by reading the at least two indicator values (block 505). The subscriber station then recovers the MBS data from the plurality of the resource units indicated by the at least two indicator values (block 507).

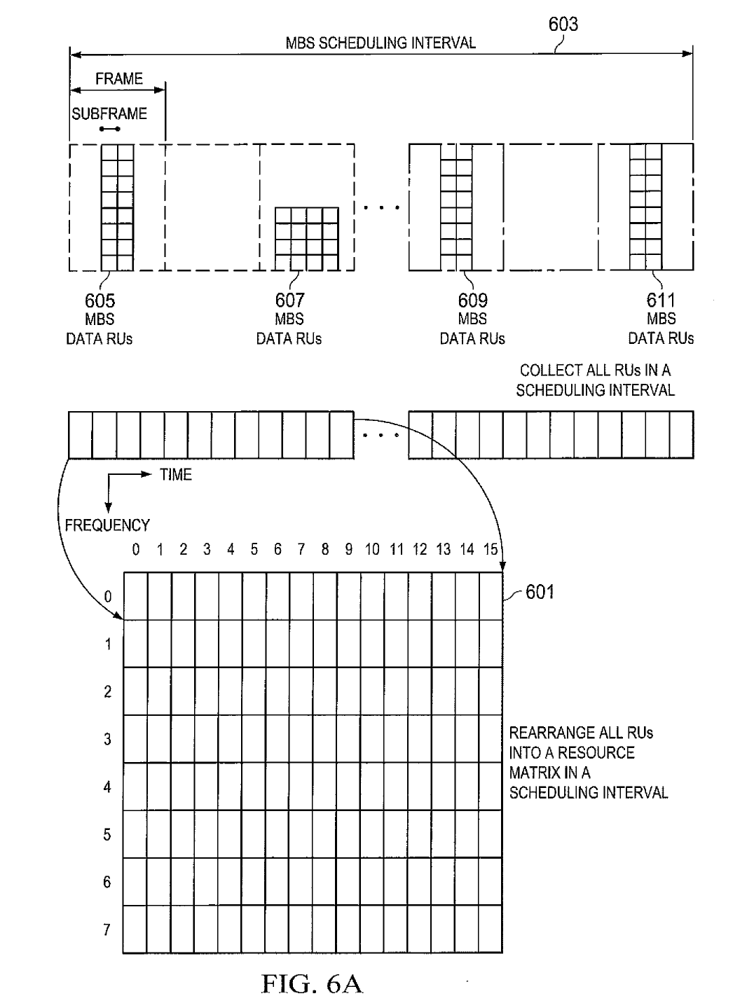

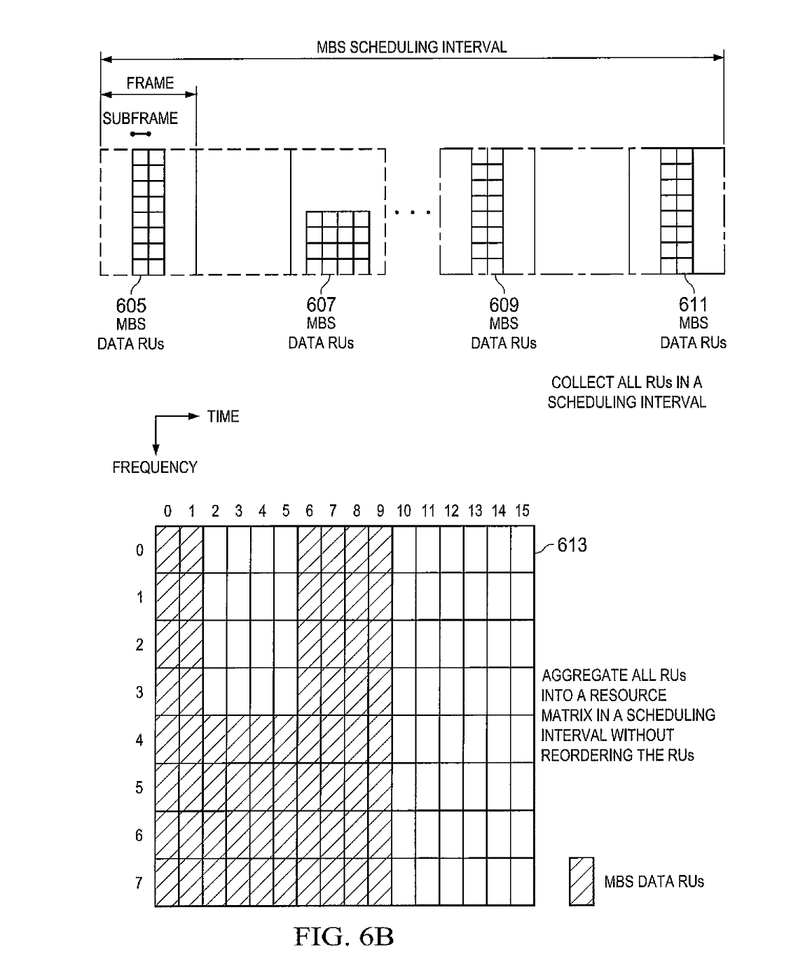

FIG. 6A illustrates a resource matrix 601 formed by aggregating the data-carrying resource units (RUs) in an E-MBS scheduling interval (MSI) 603 according to embodiments of the present disclosure. The embodiment of the resource matrix 601 shown in FIG. 6 is for illustration only. Other embodiments could be used without departing from the scope of this disclosure.

As shown in FIG. 6, MSI 603 comprises various E-MBS data-carrying RUs distributed across frames 605, 607, 609, and 611. In this particular embodiment, all of the various E-MBS data-carrying RUs in MSI 603 are aggregated and rearranged to form resource matrix 601. A resource matrix is a set of resources reserved for E-MBS according to an MSI. Such a rearrangement of E-MBS data-carrying RUs can produce a resource matrix consisting of only E-MBS data-carrying RUs such as matrix 601. However, the various E-MBS data-carrying RUs distributed across frames 605, 607, 609, and 611 also may be aggregated without re-ordering the E-MBS data-carrying RUs in such a way that the dimensions of the E-MBS data-carrying RUs of each subframe is maintained.

FIG. 6B illustrates a resource matrix 613 formed by aggregating the E-MBS data-carrying resource units (RUs) in E-MBS scheduling interval (MSI) 603 without reordering the data-carrying RUs according to embodiments of the present disclosure.

As shown in FIG. 6B, the shaded grids 615 of matrix 613 represent the E-MBS data-carrying RUs in E-MBS scheduling interval (MSI) 603. Because the dimensions of the E-MBS data-carrying RUs of each subframe are maintained, matrix 613 contains RUs that do not carry E-MBS data. The present disclosure provides an efficient signaling method and system for indicating either the E-MBS data-carrying RUs or the non-E-MBS data-carrying RUs.

Tree structures can be conveniently used to designate resource allocation due to their simple structure and low signaling overhead. For example, a first resource tree is constructed along a first dimension of a resource matrix and a second resource tree is constructed along a second dimension of the resource matrix. The first dimension can be, for example, frequency, and the second dimension can be, for example, time. In such an embodiment, RUs can be allocated by indicating a first node on the first resource tree and a second node on the second resource tree. In particular embodiments, the indication of the first node on the first resource tree and the indication of the second node on the second resource tree can be encoded separately into two message fields or jointly encoded into one message field.

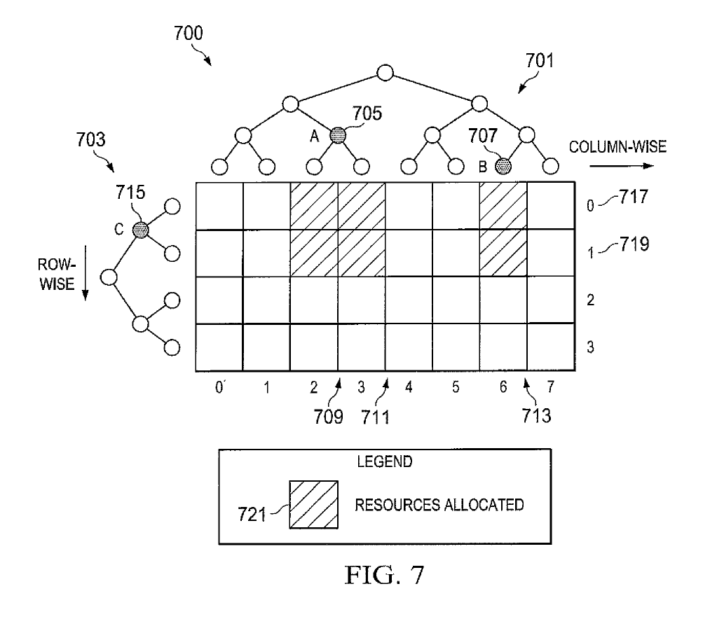

FIG. 7 illustrates the use of resource trees 701 and 703 to indicate resource units in a resource matrix 700 according to embodiments of the present disclosure. The embodiment of the resource matrix 700 shown in FIG. 7 is for illustration only. Other embodiments could be used without departing from the scope of this disclosure.

In the embodiment shown in FIG. 7, two nodes of the first resource tree 701 are assigned column-wise—node_A 705 and node_B 707—with node_A 705 representing column_2 709 and column_3 711 and node_B 707 representing column_6 713. One node is assigned row-wise—node C 715 in the second resource tree 703—representing row_0 717 and row_1 719. As such, the resource units that are located at the intersection of columns {2, 3, 6}, and rows {0, 1} are assigned. In the example illustrated in FIG. 7, the shaded grids 721 represent the resources allocated.

Although the embodiment shown in FIG. 7 is described in terms of designating the resources that are assigned to carry E-MBS data, one of ordinary skill in the art would recognize that the resource trees 701 and 703 of FIG. 7 could also be used to designate the resources that are not assigned to carry E-MBS data. In some embodiments, the choice of which resources to designate could depend on which resource is less in number in the matrix. Designating the resources that are less in number would result in less overhead.

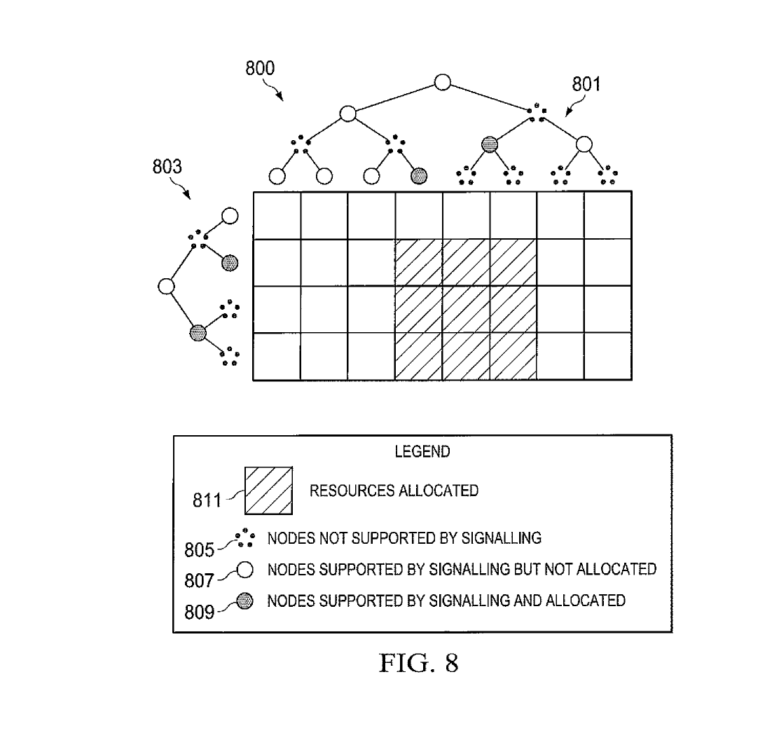

FIG. 8 illustrates the use of resource trees 801 and 803 to indicate resource units in a resource matrix 800 according to other embodiments of the present disclosure. The embodiment of the resource matrix 800 shown in FIG. 8 is for illustration only. Other embodiments could be used without departing from the scope of this disclosure.

Further signaling compression can be applied to the signaling of tree nodes allocation. In order to further reduce the signaling overhead, not all the nodes in resource tree need to be supported. For example, as shown in FIG. 8, there are fifteen nodes in a column-wise resource tree 801. Four (4) bits would be needed to signal a node if all the nodes are supported in signaling. However, if only eight (8) of the fifteen (15) nodes in the column-wise resource tree 801 are supported, then only three (3) bits are needed to signal a node in the column-wise allocation. In the embodiment shown in FIG. 8, the dashed circles 805 represent the nodes not supported by signaling, the non-dashed circles 807 represent the nodes that are supported by signaling but are not allocated, and the solid circles 809 represent the nodes that are supported by signaling and are allocated. Further, the shaded grids 811 represent the resource units that are allocated for E-MBS transmission. Likewise, four (4) out of the seven (7) nodes in the row-wise resource tree 803 are supported, which means two (2) bits are needed to signal a node in the row-wise allocation. With this compression, the resource allocation shown as the shaded grids 811 in FIG. 8 only requires ten (10) bits (two column-wise nodes and two row-wise nodes) at most, and further compression is possible.

In the example illustrated in FIG. 8, the shaded grids 805 represent the resources units that are allocated. In addition to signaling compression, the disclosed system and method provides granularity and flexibility to allocate RUs to support different types of E-MBS streams from multimedia text messages that may require only 1 RU and are transmitted only a few times in an MSI to an HD broadcast that requires multiple RUs for numerous transmissions within an MSI.

In some embodiments, the resource units in a resource matrix can be allocated by allocating a first contiguous segment in a first dimension of the resource matrix and a second contiguous segment in a second dimension of the resource matrix. Accordingly, a plurality of columns can be indicated for selectivity and a plurality of rows can be indicated for diversity in order to provide an allocation that includes both selectivity and diversity. In particular embodiments, a plurality of contiguous blocks are allocated in a dimension.

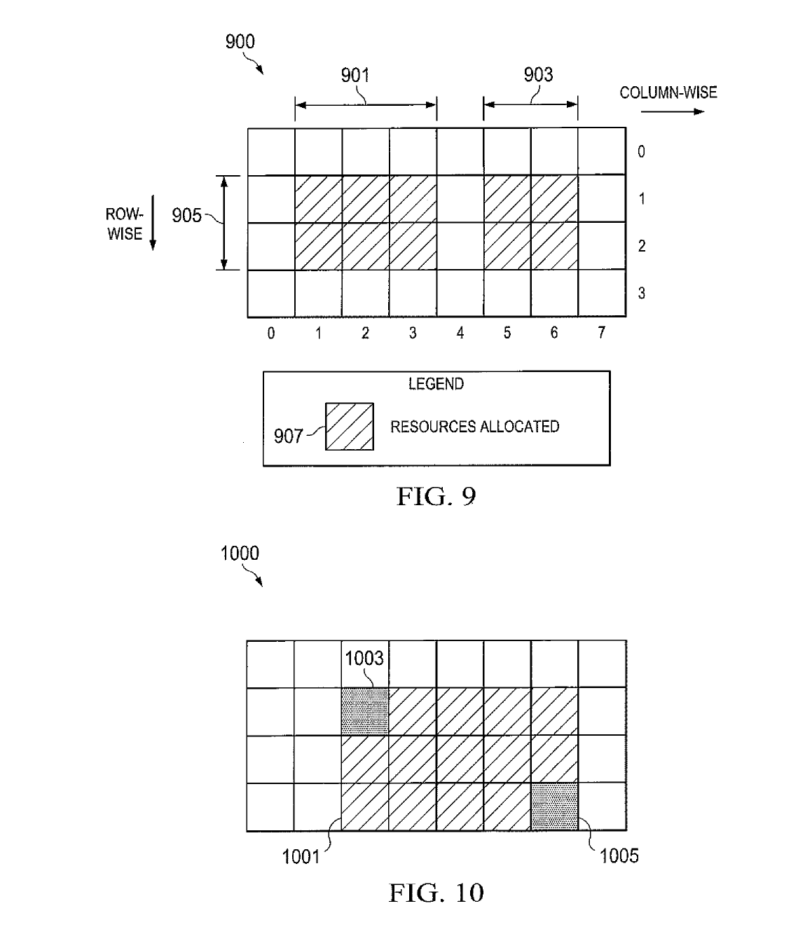

FIG. 9 illustrates a resource matrix 900 having a plurality of contiguous blocks allocated in one dimension according to embodiments of the present disclosure. The embodiment of the resource matrix 900 shown in FIG. 9 is for illustration only. Other embodiments could be used without departing from the scope of this disclosure.

As shown in FIG. 9, two contiguous segments 901, 903 are allocated column-wise, with one segment 901 representing columns 1-3 and another segment 903 representing columns 5-6. One contiguous segment 905 is allocated row-wise, representing row 1-2. As such, the resource units 907 at the intersection of columns {1, 2, 3, 5, 6} and rows {1, 2} are allocated. In FIG. 9, the shaded grids 807 represent the resource units that are allocated.

FIG. 10 illustrates block allocation according to embodiments of the present disclosure. The embodiment of the block allocation shown in FIG. 10 is for illustration only. Other embodiments could be used without departing from the scope of this disclosure.

As shown in FIG. 10, a contiguous block 1001 of resource units in a resource matrix 1000 can be allocated by indicating two resource units 1003, 1005 of the contiguous blocks 1001. In the example illustrated in FIG. 10, the shaded grids represent the resources of matrix 1000 allocated in the contiguous block 1001. The contiguous block 1001 is signaled by indicating the starting resource unit 1003 and the ending resource unit 1005. In particular embodiments, the signaling for the indication of the resource unit 1003 where the E-MBS data stream begins and the signaling of the indication of the resource unit 1005 where the E-MBS data stream ends can be encoded separately into two message fields or jointly encoded into one message field. In some cases, the signaling for the indication of the resource unit 1003 where the E-MBS data stream begins can also be used to signal the end of the previous E-MBS stream at the previous resource unit prior to the resource unit 1003, and signaling the resource for indicating the resource unit 1005 where the E-MBS data stream ends can also be used to signal the beginning of a new E-MBS stream from the next succeeding resource unit.

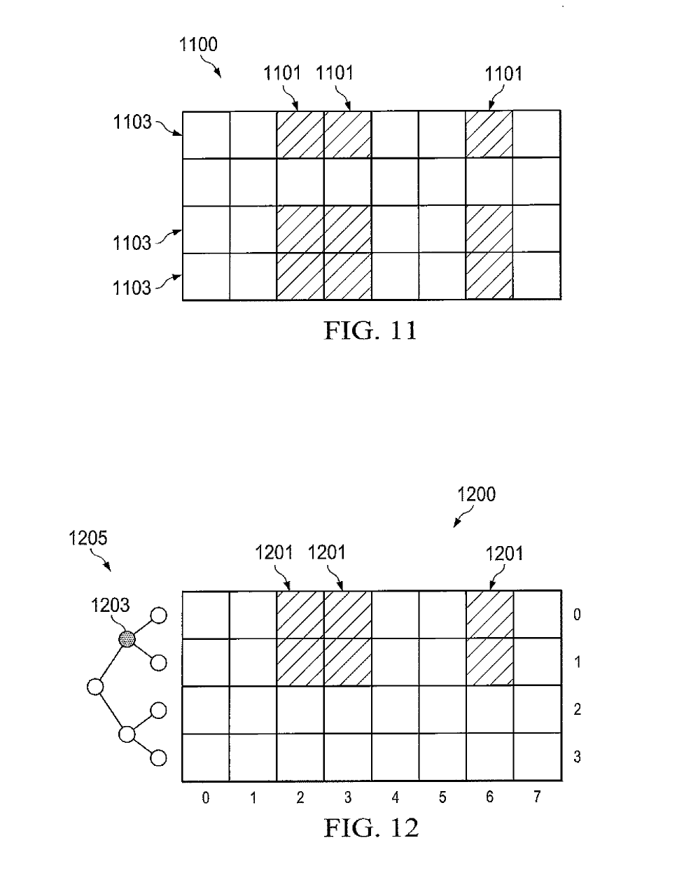

FIG. 11 illustrates best-M allocation according to embodiments of the present disclosure. The embodiment of the best-M allocation shown in FIG. 11 is for illustration only. Other embodiments could be used without departing from the scope of this disclosure.

As shown in FIG. 11, a plurality of columns 1101 and a plurality of rows 1103 of a resource matrix 1100 are indicated in a resource allocation message such that the resource units at the intersection of the plurality of columns 1101 and the plurality of rows 1103 are allocated for a transmission. In the example illustrated in FIG. 11, the shaded grids of resource matrix 1100 represent the resource units allocated for transmission. In some embodiments, the selected plurality of rows (or columns) correspond to the resource units that have a favorable channel condition such that the communication can be more reliable and support higher data rate. Such a scheme also is referred to as a best-M scheme. In the example shown in FIG. 11, the best-3 columns 1101 and the best-3 rows 1103 are selected.

FIG. 12 illustrates a column-wise best-M and row-wise tree allocation according to embodiments of the present disclosure. The embodiment of the allocation shown in FIG. 12 is for illustration only. Other embodiments could be used without departing from the scope of this disclosure.

In some embodiments, a first resource allocation scheme is used in a first dimension of a resource matrix 1200 and a second resource allocation scheme is used in a second dimension of the resource matrix 1200. The resource allocation scheme can be, but is not limited to, a tree allocation, a segment allocation, a block allocation, or a best-M allocation. For example, as shown in FIG. 12, a Best-M can be used in column-wise allocation and a resource tree is used in row-wise allocation. In this particular embodiment, three columns 1201 are selected by the column-wise best-M allocation. One node 1203 is selected by the row-wise resource tree 1205 allocation. In the example illustrated in FIG. 12, the shaded grids of resource matrix 1200 represent the resource units allocated for transmission. As such, the resource units at the intersection of columns {2, 3, 6} and rows {0, 1} are allocated.

In some embodiments, further channelization or subcarrier permutation can be applied to resources allocated on a resource matrix. For example, further channelization can be applied to further increase diversity. Any one of a combination of the aforementioned methods can be used to allocate resource units on a resource matrix. In order to obtain diversity, multiple resource units may need to be allocated, or channelization is performed to enable a diversity transmission using only one resource unit. As such, after allocation in which a plurality of resource units is allocated, channelization is performed on the allocated resource units. Sub-carriers are taken from each of the allocated resource units and grouped into one distributed resource unit. Therefore, only a portion of the distributed resource units are used, through channelization, to create another set of distributed resource units wherein only one allocated unit.

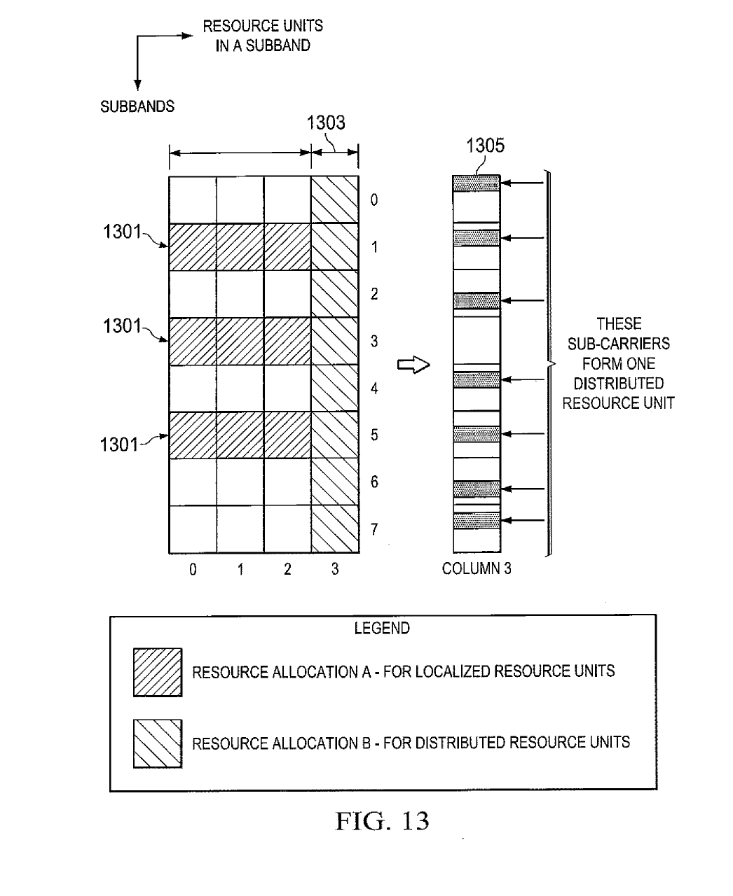

FIG. 13 illustrates a further channelization for resource allocation on a resource matrix according to embodiments of the present disclosure. The embodiment of the channelization shown in FIG. 13 is for illustration only. Other embodiments could be used without departing from the scope of this disclosure.

As shown in FIG. 13, the resource units that are allocated can be further channelized. Each row represents a frequency sub-band that includes four (4) contiguous resource units. Resource allocation A allocates the resource units at the intersection of columns {0, 1, 2} and rows {1, 3, 5} to a particular transmission. Such an allocation allows the scheduler to choose the best three (3) sub-bands 1301 (rows {1, 3, 5} for this particular transmission) and allocates three (3) resource units in each sub-band. Resource allocation B allocates all the resource units in a column 1303 for distributed resource units. Distributed resource units are constructed on all the resource units of column 1303. An additional example is shown at a column 1305 on the right hand side of FIG. 13. The sub-carriers in the resource units of column 1305 are further distributed to a plurality of distributed resource units. By distributing the sub-carriers, each distributed resource unit can obtain higher frequency diversity as compared to localized resource units in which all sub-carriers are contiguous.

For ease of discussion, the embodiments of the present disclosure are described in relation to a two-dimensional resource matrix. However, one of ordinary skill in the art would recognize that the methods and systems disclosed are certainly applicable to matrices with higher dimensions. For example, a third dimension can be added to the resource matrix to accommodate resource allocation in a multiple-input-multiple-output (MIMO) system. In IEEE 802.16m, MIMO with spatial multiplexing is one of the transmission modes for E-MBS. In such a case, the third dimension represents the spatial dimension, which can be antennas, virtual antennas, spatial layers, spatial streams, or MIMO codewords.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A base station comprising:
a controller configured:
to construct a resource matrix comprising resource units,
to allocate a plurality of resource units within the resource matrix containing resource units that carry Enhanced-Multicast Broadcast Service (E-MBS) data, and
to generate at least two indicator values, the at least two indicator values configured to identify at least some of the plurality of resource units containing E-MBS data within the resource matrix; and
a transmitter configured to transmit the E-MBS data placed in the resource matrix and the at least two indicators to a subscriber station.

2. A base station in accordance with claim 1 wherein a first resource tree is constructed along a first dimension of the resource matrix and a second resource tree is constructed along a second dimension of the resource matrix.

3. A base station in accordance with claim 2 wherein the at least two indicators identify a first node on the first resource tree and a second node on the second resource tree, and
wherein at least some of the plurality of resource units transmitting E-MBS data are located at an intersection of the first node on the first resource tree and the second node on the second resource tree

4. A base station in accordance with claim 1 wherein the at least two indicators indentify at least some of the plurality of resource units transmitting E-MBS data by indicating a first contiguous segment in a first dimension of the resource matrix and a second contiguous segment in a second dimension of the resource matrix.

5. A base station in accordance with claim 1 wherein the at least two indicators indentify a first contiguous segment in a first dimension of the resource matrix and two or more contiguous segments in a second dimension of the resource matrix, and
wherein at least some of the plurality of resource units transmitting E-MBS data are located at an intersection of the first contiguous segment in the first dimension of the resource matrix and the two or more contiguous segments in the second dimension of the resource matrix.

6. A base station in accordance with claim 1 wherein at least some of the plurality of resource units transmitting E-MBS data are allocated in a contiguous block, and
wherein the at least two indicators indicate a first corner of the contiguous block and a second corner of the contiguous block, the second corner being diagonal from the first corner.

7. A base station in accordance with claim 1 wherein the at least two indicators indicate a plurality of columns and a plurality of rows of the resource matrix, and
wherein at least some of the plurality of resource units transmitting E-MBS data are at an intersection of the plurality of columns and the plurality of rows.

8. A base station in accordance with claim 1 wherein a first resource allocation scheme is applied to a first dimension of the resource matrix and a second resource allocation scheme is applied to a second dimension of the resource matrix, and
wherein the first resource allocation scheme is different from the second resource allocation scheme.

9. A base station in accordance with claim 1 wherein the controller is further configured to apply further channelization to the plurality of resource units transmitting E-MBS data.

10. A method of transmitting Enhanced-Multicast Broadcast Service (E-MBS) data, the method comprising:
constructing a resource matrix comprising resource units;
allocating a plurality of resource units within the resource matrix containing resource units that carry E-MBS data;
generating at least two indicator values, the at least two indicator values configured to identify at least some of the plurality of resource units containing E-MBS data; and
transmitting the E-MBS data placed in the resource matrix and the at least two indicators to a subscriber station.

11. A subscriber station comprising:
a receiver configured to receive resource matrix and at least two indicators; and
a controller configured:
to use the at least two indicators to determine a plurality of resource units within the resource matrix that carry Enhanced-Multicast Broadcast Service (E-MBS) data, and
to recover E-MBS data from the plurality of resource units within the resource matrix that carry E-MBS data.

12. A subscriber station in accordance with claim 11 wherein the resource matrix comprises a first resource tree constructed along a first dimension of the resource matrix and a second resource tree constructed along a second dimension of the resource matrix.

13. A subscriber station in accordance with claim 12 wherein the at least two indicators identify a first node on the first resource tree and a second node on the second resource tree, and
wherein at least some of the plurality of resource units transmitting E-MBS data are located at an intersection of the first node on the first resource tree and the second node on the second resource tree

14. A subscriber station in accordance with claim 11 wherein the at least two indicators indentify at least some of the plurality of resource units transmitting E-MBS data by indicating a first contiguous segment along a first dimension of the resource matrix and a second contiguous segment along a second dimension of the resource matrix.

15. A subscriber station in accordance with claim 11 wherein the at least two indicators indentify a first contiguous segment along a first dimension of the resource matrix and two or more contiguous segments along a second dimension of the resource matrix, and
wherein at least some of the plurality of resource units transmitting E-MBS data are located at an intersection of the first contiguous segment along the first dimension of the resource matrix and the two or more contiguous segments along the second dimension of the resource matrix.

16. A subscriber station in accordance with claim 11 wherein at least some of the plurality of resource units transmitting E-MBS data are allocated in a contiguous block, and
wherein the at least two indicators indicate a first corner of the contiguous block and a second corner of the contiguous block, the second corner being diagonal from the first corner.

17. A subscriber station in accordance with claim 11 wherein the at least two indicators indicate a plurality of columns and a plurality of rows of the resource matrix, and
wherein at least some of the plurality of resource units transmitting E-MBS data are at an intersection of the plurality of columns and the plurality of rows.

18. A subscriber station in accordance with claim 11 wherein a first resource allocation scheme is applied to a first dimension of the resource matrix and a second resource allocation scheme is applied to a second dimension of the resource matrix, and
wherein the first resource allocation scheme is different from the second resource allocation scheme.

19. A method of receiving Enhanced-Multicast Broadcast Service (E-MBS) data, the method comprising:
receiving a resource matrix and at least two indicators;
using the at least two indicators to determine a plurality of resource units within the resource matrix that carry E-MBS data;
and recovering E-MBS data from the plurality of resource units within the resource matrix that carry E-MBS data.

20. A wireless communication network comprising a plurality of base stations capable of wireless communication with a plurality of subscriber stations within a coverage area of the network, wherein at least one of the plurality of base stations comprises:
a controller configured:
to construct a resource matrix comprising resource units,
to allocate a plurality of resource units within the resource matrix containing resource units that carry Enhanced-Multicast Broadcast Service (E-MBS) data, and
to generate at least two indicator values, the at least two indicator values configured to identify at least some of the plurality of resource units containing E-MBS data within the resource matrix; and
a transmitter configured to transmit the data placed in the resource matrix and the at least two indicators to a subscriber station.

21. A base station comprising:
a controller configured:
to identify a resource matrix in a time-frequency domain,
to allocate a plurality of resource units within the resource matrix to carry a data stream, wherein the resource matrix comprises a plurality of resource units, and
to generate a message comprising at least two indicators identifying a resource unit within the resource matrix, wherein the resource unit indicates one of a first and a last resource unit of the data stream; and
a transmitter configured to transmit the data stream and the message.

22. The base station in accordance with claim 21, wherein the data stream comprises Enhanced-Multicast Broadcast Service (E-MBS) data.

23. The base station in accordance with claim 21, wherein a first indicator of the at least two indicators indicates a temporal location of the resource unit in the time domain and a second indicator of the at least two indicators indicates a frequency location in the frequency domain.

24. The base station in accordance with claim 21, wherein the at least two indicators are jointly encoded in a field of the message.

25. The base station in accordance with claim 21, wherein each of the at least two indicators is encoded in a field of the message.

26. A wireless communication network comprising a plurality of base stations capable of wireless communication with a plurality of subscriber stations within a coverage area of the network, wherein at least one of the plurality of base stations comprises:
a controller configured:
to identify a resource matrix in a time-frequency domain,
to allocate a plurality of resource units within the resource matrix to carry a data stream, wherein the resource matrix comprises a plurality of resource units, and
to generate a message comprising at least two indicators identifying a resource unit within the resource matrix, wherein the resource unit indicates one of a first and a last resource unit of the data stream; and
a transmitter configured to transmit the data stream and the message.

27. The network in accordance with claim 26, wherein the data stream comprises Enhanced-Multicast Broadcast Service (E-MBS) data.

28. The network in accordance with claim 26, wherein a first indicator of the at least two indicators indicates a temporal location of the resource unit in the time domain and a second indicator of the at least two indicators indicates a frequency location in the frequency domain.

29. The network in accordance with claim 26, wherein the at least two indicators are jointly encoded in a field of the message.

30. The network in accordance with claim 26, wherein each of the at least two indicators is encoded in a field of the message.
